(19) United States
(12) Patent Application Publication
(10) Pub. No.: US 2010/0005695 A1
(43) Pub. Date: Jan. 14, 2010

(54) DISPLAY DEVICE AND SPRING STRUCTURE THEREOF

(75) Inventors: Wen-Hung Huang, Taipei County (TW); Yi-Cheng Chen, Taipei County (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: HANNSPREE, INC., Taipei City (TW)

(21) Appl. No.: 12/275,336

(22) Filed: Nov. 21, 2008

(30) Foreign Application Priority Data
Jul. 8, 2008 (TW) 097125671

(51) Int. Cl. A47G 1/06; F16F 1/18

(52) U.S. Cl. 40/792; 267/164

(57) ABSTRACT

A spring structure of the invention is provided, including a main body having a top portion and two lateral portions extending from the top portion, a plurality of tabs protruding inward from the lateral portions to engage the main body to the device, and a spring extending from the top portion with a curved shape.

### CROSS REFERENCE TO RELATED APPLICATIONS

This Application claims priority of Taiwan Patent Application No. 097125671, filed on Jul. 8, 2008, the entirety of which is incorporated by reference herein.

### BACKGROUND OF THE INVENTION

1. Field of the Invention

The present invention relates to a spring structure, and in particular relates to a spring structure securing a panel to a frame in a display device.

2. Description of the Related Art

For the manufacturing or frame displacement of a conventional digital photo frame or conventional display device, a panel is secured to a frame by bolts. However, the fastening method results in difficulties when replacing or securing the frame, leading to increased labor and time.

### BRIEF SUMMARY OF INVENTION

An embodiment of a spring structure of the invention comprises a main body having a top portion and two lateral portions extending from the top portion, a plurality of tabs protruding inward from the lateral portions to engage the main body to the device, and a spring extending from the top portion with a curved shape.

The top portion has an appropriate curvature. When the main body engages the device, the spring has a curvature smaller than the top portion.

The tabs are formed by punching the lateral portions to make a part of the lateral portion protrude inward. The tabs are triangular.

The spring is formed by punching the top portion to make a part of the top portion protrude outward.

A detailed description is given in the following embodiments with reference to the accompanying drawings.

### BRIEF DESCRIPTION OF DRAWINGS

The present invention can be more fully understood by reading the subsequent detailed description and examples with references made to the accompanying drawings, wherein:

FIG. 1 is a schematic view of a part of a display device of the invention;

FIG. 2 is a perspective view of a spring structure of the invention;

FIG. 3 is a schematic view of the metal sheet for manufacturing the spring structure of the invention; and

FIGS. 4˜6 are schematic view showing the steps of the panel being secured by the spring structure.

### DETAILED DESCRIPTION OF INVENTION

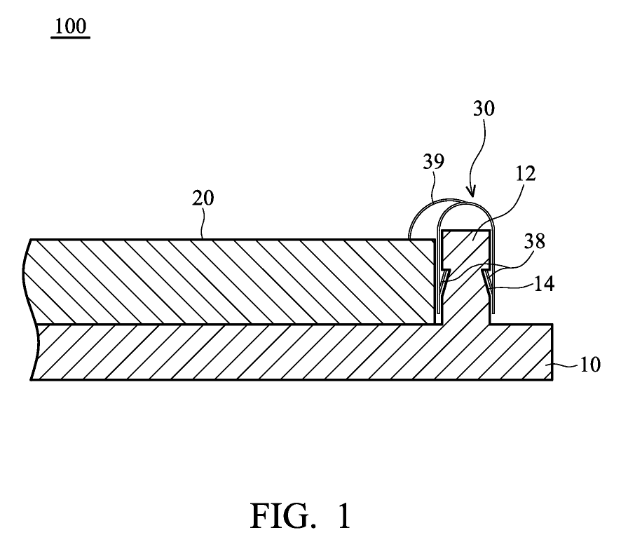

Referring to FIG. 1, a display device 100 comprises a frame 10, a panel 20 and a plurality of spring structures 30. The frame 10 has a flange 12. The panel 20 is secured to the frame 10. The spring structure 30 engages the flange 12 and the tip of a spring 39 of the spring structure 30 biases the panel 20, whereby the panel 20 is secured to the frame 10. The display device 100 is flat panel display or digital photo frame.

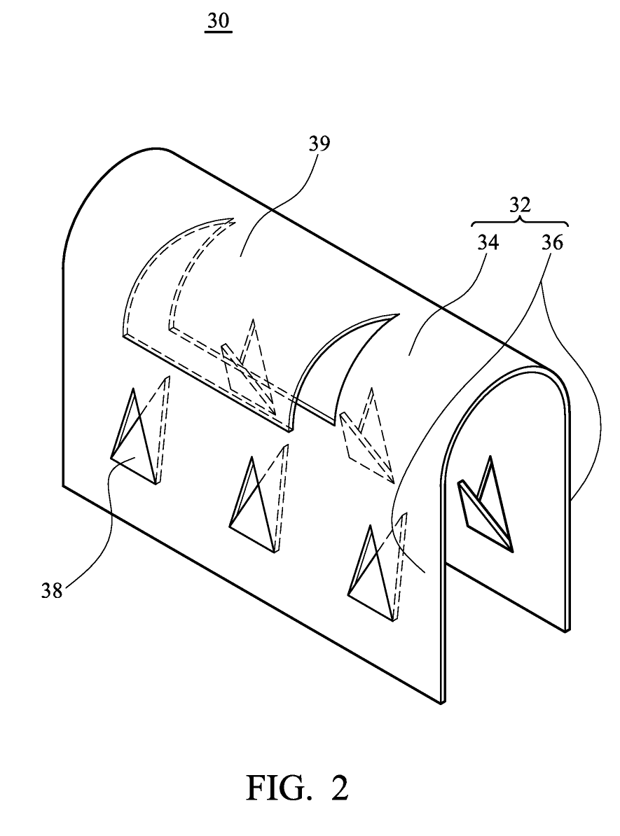

The spring structure 30 is U-shaped, as shown in FIG. 2, and comprises a main body 32 which has a top portion 34 and two lateral portions 36 extending from the top portion 34. The lateral portions 36 face each other. A plurality of tabs 38 is formed by punching the lateral portions 36 to make a part of the lateral portions 36 protrude inward. The tabs 38 are triangular. The tabs 38 engage a plurality of holes 14 on the flange 12, whereby the main body 32 engages the flange 12. The spring structure 30 further has a spring 39 extending from the top portion 34. The spring 39 is formed by punching the top portion 34 to make a part of the top portion 34 protrude outward.

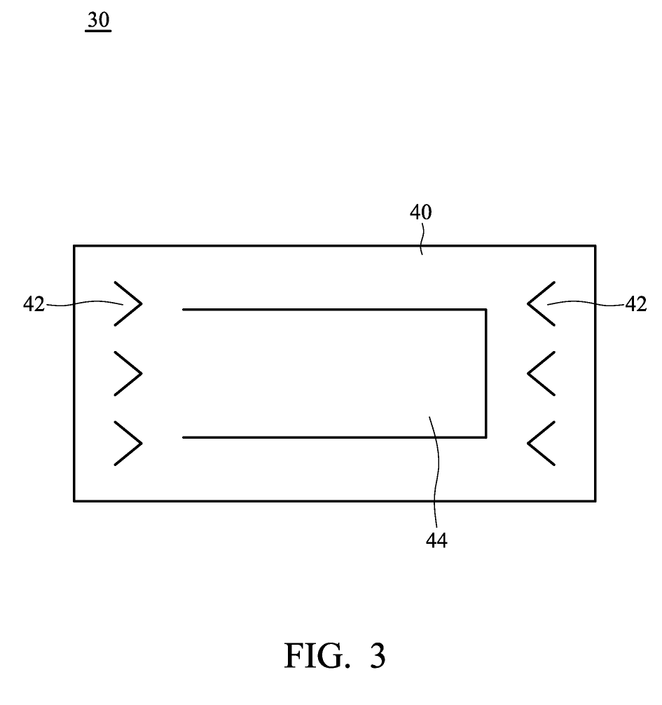

The manufacturing method for the spring structure 30 is described as follows. Patterns 42 and 44, as shown in FIG. 3, are formed by punching a rectangular metal sheet 40. The patterns 42 and 44 are partially connected to the metal sheet 40. The metal sheet 40 is bent to a U-shape comprising the curved top portion 34 and two lateral portions 36. The triangular pattern 42 is pushed inward to form the tabs 38. The pattern 44 forms the spring 39.

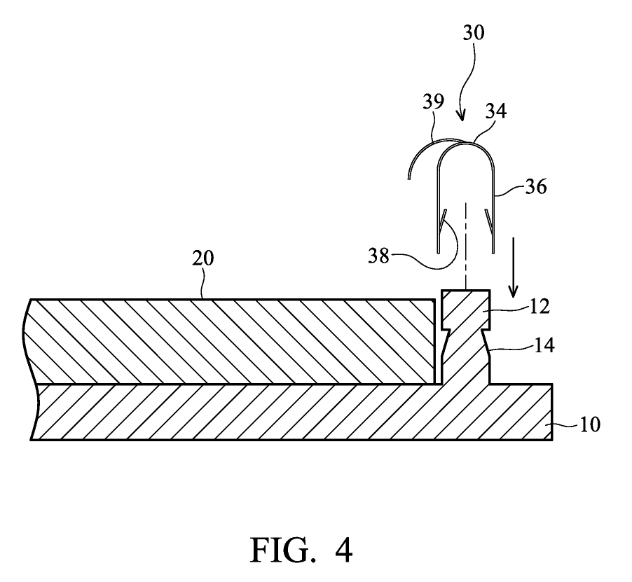

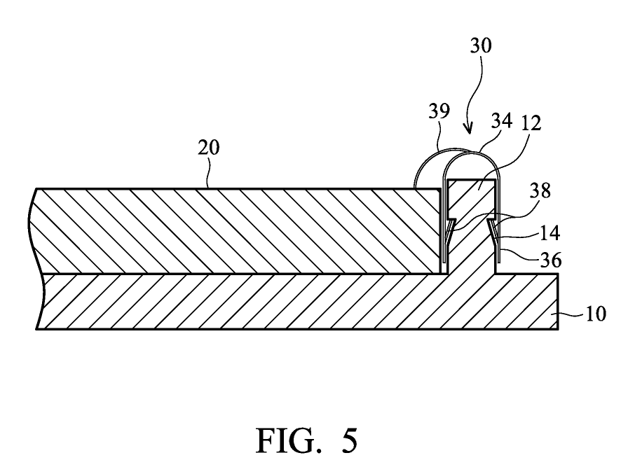

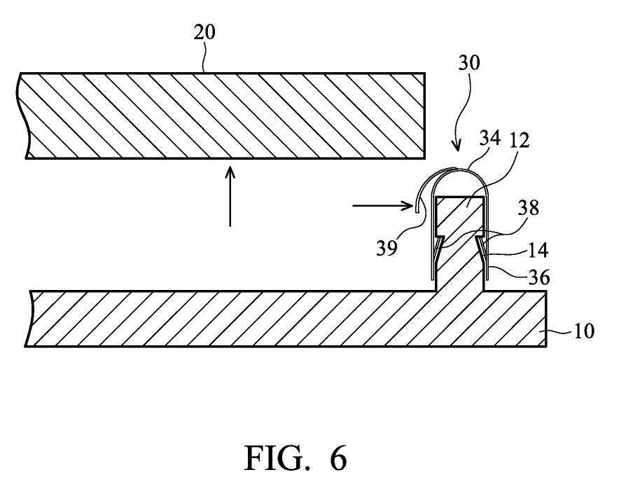

When the spring structure 30 is used to secure the panel 20 to the frame 10, the U-shaped spring structure 30 is pushed to the frame 10, as shown in FIG. 4. The tabs 38 engages the holes 14 of the flange 12, whereby the main body 32 is secured to the flange 12, as shown in FIG. 5, and the spring 39 extends from the top portion 34. The tip of the spring 39 biases the panel 20 with appropriate force, whereby the panel 20 is secured to the frame 10.

When the frame 10 is needed to be replaced, the spring 39 is pushed inward to release the spring 39 from the panel 20, whereby the panel 20 is removed from the frame 10.

When the spring structure 30 engages the frame 10, the panel 20 is secured to the frame 10. The replacement of the frame 10 is done by pushing the spring. Bolts are not needed, which saves labor and time when replacing or securing the frame.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. A spring structure for a device, comprising:
a main body having a top portion and two lateral portions extending from the top portion;
a plurality of tabs protruding inward from the lateral portions to engage the main body to the device; and
a spring extending from the top portion with a curved shape and having the same curved direction as the top portion.

2. (canceled)

3. The spring structure as claimed in claim 1, wherein when the main body engages the device, the spring has a curvature smaller than the top portion.

4. The spring structure as claimed in claim 1, wherein the tabs are formed by punching the lateral portions to make a part of the lateral portion protrude inward.

5. The spring structure as claimed in claim 4, wherein the tabs are triangular.

6. The spring structure as claimed in claim 1, wherein the spring is formed by punching the top portion to make a part of the top portion protrude outward.

7. A display device, comprising:
a frame having a plurality of holes; and
at least one spring structure comprising:
a main body having a top portion and two lateral portions extending from the top portion;
a plurality of tabs protruding inward from the lateral portions to engage the holes, whereby the main body engages the frame; and
a spring extending from the top portion with a curved shape and having the same curved direction as the top portion.

8. (canceled)

9. The display device as claimed in claim 7, wherein when the main body engages the device, the spring has a curvature smaller than the top portion.

10. The display device as claimed in claim 7, wherein the tabs are formed by punching the lateral portions to make a part of the lateral portion protrude inward.

11. The display device as claimed in claim 10, wherein the tabs are triangular.

12. The display device as claimed in claim 7, wherein the spring is formed by punching the top portion to make a part of the top portion protrude outward.
